(19) United States
(12) Patent Application Publication
(10) Pub. No.: US 2025/0024776 A1
(43) Pub. Date: Jan. 23, 2025

(54) HYBRID MOWER

(71) Applicant: Daye North America, Inc., Charlotte, NC (US)

(72) Inventors: Justin Andrikanich, Concord, NC (US); Steven Michael Brodecky, Charlotte, NC (US); Larissa Day, Huntersville, NC (US); Joel George Hope, Concord, NC (US)

(21) Appl. No.: 18/779,010

(22) Filed: Jul. 21, 2024

Related U.S. Application Data
(60) Provisional application No. 63/528,370, filed on Jul. 22, 2023.

(51) Int. Cl. A01D 34/58; A01D 34/00; A01D 69/02; A01D 101/00

(52) U.S. Cl. CPC A01D 34/58; A01D 34/006; A01D 69/025; A01D 2101/00

(57) ABSTRACT

A mower with a hybrid electric power system and a method of operation therefor. The mower comprises a drive wheel for propelling the mower, a cutting unit configured to cut grass, a first motor operatively connected to the drive wheel, a second motor operatively connected to the cutting unit, a primary battery and a generator connected to the first motor and the second motor to each independently power the first motor and the second motor, and a control unit configured to switch the mower between operating conditions when it is powered by the primary battery or by the generator. An auxiliary battery is connected to the first motor and can power the first motor to drive the mower when the primary battery is out of charge and the generator is out of fuel.

### CROSS-REFERENCE TO RELATED APPLICATIONS

This application claims priority to U.S. Provisional Patent Application No. 63/528,370, filed on Jul. 22, 2023, to Joel George Hope et al., entitled “Hybrid Mower,” currently pending, the entire disclosure of which is incorporated herein by reference.

### BACKGROUND OF THE INVENTION

The present invention relates to power and operating systems for lawn mowers and other types of lawn equipment and recreational or utility vehicles. Mowers typically must power both a drive system that propels the mower and a cutting blade system. Traditionally, mowers have an internal combustion engine to power both the drive system and the cutting blade system. These internal combustion engines can be inefficient over the range of power draws required by a mower.

To provide greater efficiency, some mowers are electric and utilize batteries to power the drive system and the cutting blade system. However, high power draw can quickly drain or discharge the batteries leading to limited operating availability of an electric mower. Moreover, battery powered mowers can have lower peak power capabilities than some traditional engine powered mowers. Battery powered mowers can also lack the necessary range or require burdensome battery capacities to provide the necessary range to complete typical mowing jobs. Thus, some mowers use a hybrid engine and battery powered system. However, known hybrid mower systems can be more difficult to operate. Additionally, current hybrid mowers lack efficiency and control and are not suitably design for typical mower needs.

Accordingly, a need exists for a hybrid power mower that has the efficiency advantages of a battery powered mower while having the operational availability and peak power capabilities of an engine powered mower. Further, a need exists for a hybrid system that is user friendly and convenient for typical mower usage.

### SUMMARY OF THE INVENTION

The present invention is directed generally to a hybrid riding lawn mower, and particularly to a hybrid power system for a mower. The hybrid power system of the present invention may also be suitably incorporated into a variety of different lawn equipment and other utility or recreational vehicles, including without limitation, tractors, zero turn mowers, walk mowers, UTVs, motor bikes, golf carts, and go-karts, and the like.

The mower may include both a primary battery and a generator. The primary battery may be configured to independently power an electric motor for a drive wheel or wheels to move the mower and an electric motor for powering the cutting unit of the mower. The generator may also be configured to, in tandem with the primary battery or independently from the primary battery, power the electric motor for the drive wheel or wheels of the mower and the electric motor for powering the cutting unit of the mower. The primary battery can be charged via an electric power source prior to operation and can also be charged by excess electric power from the generator when the generator is powering the motors. The generator may be powered by an engine, such as an internal combustion engine, to produce electricity. The engine may be an integral component of the generator or may be separate from the generator and mechanically coupled thereto to power the generator. The mower may also include an auxiliary battery, such as a battery typically used for power tools and equipment or any other suitable battery type, for powering the electric motor for the drive wheel or wheels in the event that the primary battery and generator are both low on charge or fuel. The auxiliary battery may be removable from the mower and used to power other devices and equipment.

In one embodiment, a mower comprising a frame; a drive wheel for propelling the mower, the drive wheel coupled to the frame; a cutting unit configured to cut grass; a first motor operatively connected to the drive wheel; a second motor operatively connected to the cutting unit; a primary energy storage device electrically connected to the first motor and the second motor to power the first motor and the second motor; an auxiliary energy storage device electrically connected to the first motor to power the first motor; a generator electrically connected to the first motor and the second motor to selectively power the first motor and the second motor, the generator further electrically connected to the primary energy storage device and the auxiliary energy storage device to selectively charge the primary energy storage device and the auxiliary energy storage device; a control unit configured to operate the mower in a first operating condition in which the primary energy storage device electrically powers the first motor and the second motor and a second operating condition in which the generator electrically powers the first motor and the second motor and charges the primary energy storage device and auxiliary energy storage device; and a control switch configured to operate the mower in a third operating condition in which the auxiliary energy storage device electrically powers the first motor when the control switch is selected.

In some embodiments, the control unit is configured to measure a charge level of the primary energy storage device. When the mower is in the first operating condition and the charge level of the primary energy storage device is measured at or below a low threshold, the control unit switches the mower to the second operating condition, and when the mower is in the second operating condition and the charge level of the primary energy storage device is measured at or above a high threshold, the control unit switches the mower to the first operating condition.

In some embodiments, the control unit can measure a power draw of the first motor and the second motor. When the mower is in the first operating condition and the power draw of the first motor and the second motor exceeds a high power threshold, the control unit switches the mower to a fourth operating condition in which the primary energy storage device powers the first motor and the second motor, and the generator powers the first motor and the second motor. In certain embodiments, while in the fourth operating condition, the generator also charges the primary energy storage device and auxiliary energy storage device.

Further advantages, features and details of the invention are elucidated on the basis of preferred embodiments thereof, wherein reference is made to the accompanying drawings.

### DESCRIPTION OF THE SEVERAL VIEWS OF THE DRAWINGS

In the accompanying drawings, which form a part of the specification and are to be read in conjunction therewith in which like reference numerals are used to indicate like or similar parts in the various views:

FIG. 1 is a side perspective view of a mower according to one embodiment of the present invention;

FIG. 2 is a bottom-rear perspective view of the mower of FIG. 1;

FIG. 3 is an upper rear perspective view of the mower of FIG. 1;

FIG. 4 is a schematic block diagram of hybrid power system for the mower of FIG. 1; and

FIG. 5 is a side perspective view of the mower of FIG. 1 with additional equipment attached to the mower.

### DETAILED DESCRIPTION OF THE INVENTION

Various embodiments of the present invention are described and shown in the accompanying materials, descriptions, instructions, and drawings. For purposes of clarity in illustrating the characteristics of the present invention, proportional relationships of the elements have not necessarily been maintained in the drawings. It will be understood that any dimensions included in the drawings are simply provided as examples and dimensions other than those provided therein are also within the scope of the invention.

The description of the invention references specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The present invention is defined by the appended claims and the description is, therefore, not to be taken in a limiting sense and shall not limit the scope of equivalents to which such claims are entitled.

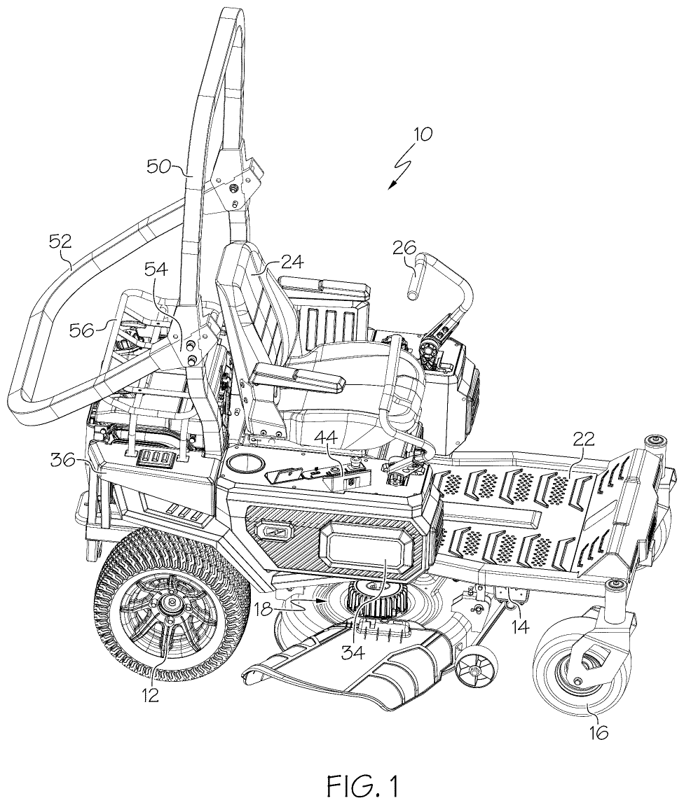

As best shown in FIG. 1, a vehicle, outdoor power equipment, or mower 10 may be driven or propelled by one or more drive wheels 12 attached to the chassis or frame 14 of the mower 10. The mower 10 may have one or more non-drive or idler wheels 16 attached to the frame 14. For example, as shown, the mower 10 may have two rear drive wheels 12 and two front idler wheels 16, which may be caster-type wheels. In other embodiments, the drive wheels 12 may be located at the front and the idler wheels 16 located at the rear. In other embodiments, more or fewer drive wheels 12 may be used (e.g., four drive wheels 12 providing an all-wheel drive system).

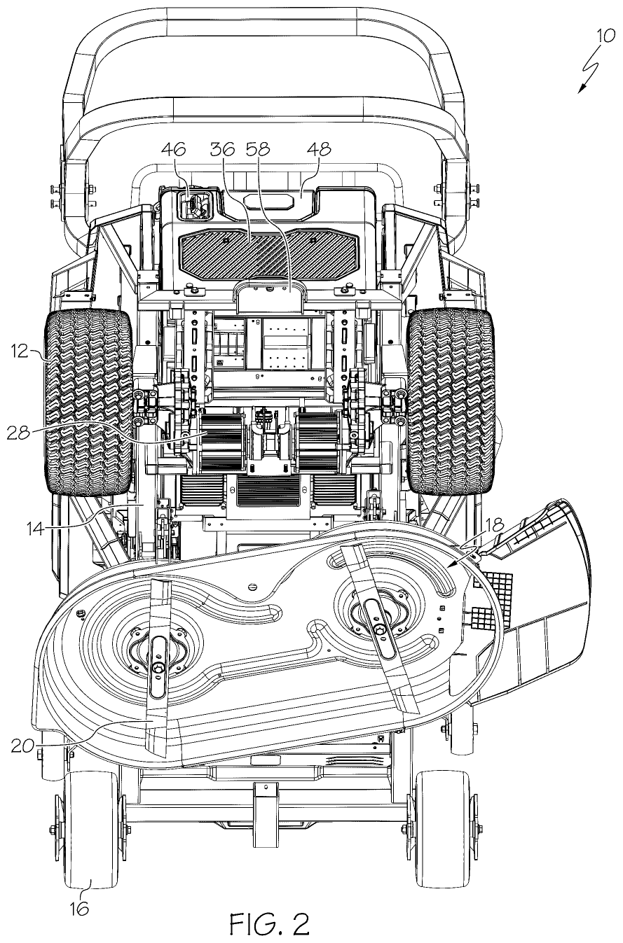

The mower 10 may include an accessory system or cutting unit 18. The cutting unit 18 may include one or more cutting blades 20 (FIG. 2) configured to rotate in a horizontal cutting plane about a vertical axis of the cutting unit 18 to cut or shear grass. The cutting unit 18 may be located on a lower or underside of the frame 14, such as underneath a deck 22. In other embodiments, the vehicle or mower 10 may include accessory systems 18 such as lights, wenches, snow blower attachments, or tiller/cultivator attachments, for example.

The mower 10 may include an operator seat 24 for an operator to ride the mower 10 during operation. The mower 10 may include a steering wheel or steering lever(s) 26 for the operator to control the direction and/or speed of the mower 10. For example, as shown, the mower 10 may include left and right steering levers 26, each of which can individually control corresponding left and right drive wheels 12.

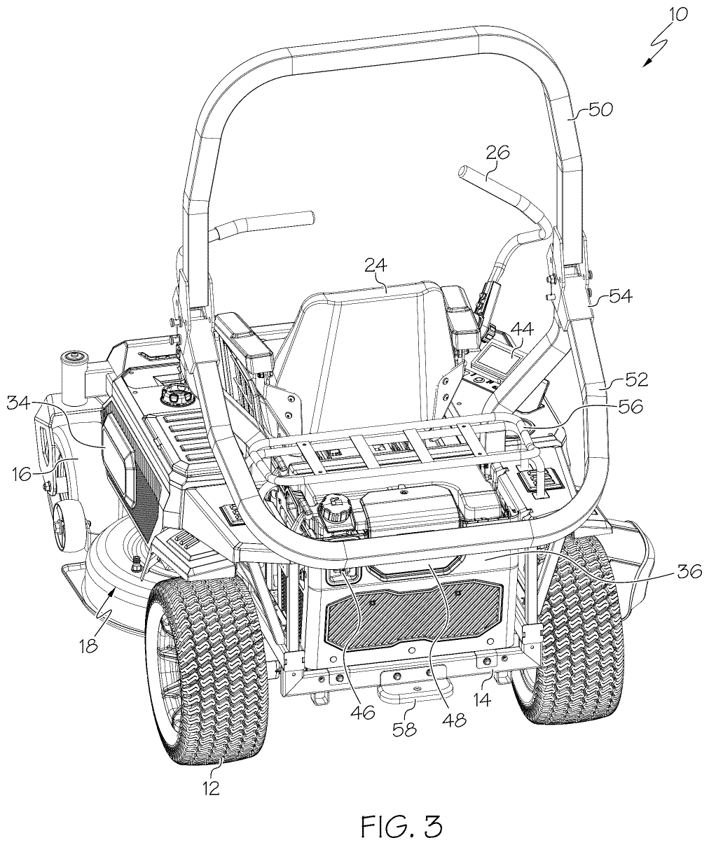

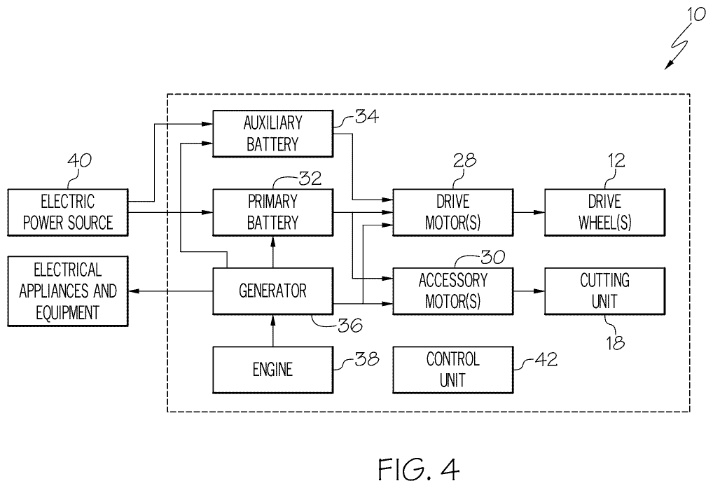

As best shown in FIGS. 2 and 3, the one or more drive wheels 12 may be powered to move by one or more electric drive motors 28. Likewise, the cutting unit 18 may be powered to operate by one or more electric accessory motors 30 (FIG. 4). In some embodiments, the motors 28, 30 may be directly mechanically coupled to the respective drive wheels 12 and cutting unit 18. In other embodiments, one or both types of motors 28, 30 may be indirectly coupled to the respective drive wheels 12 or cutting unit 18 via a system of belts, gears, or other mechanical or hydraulic connections. The motors 28 and 30 may be configured as any standard or suitable type of electrical motor now known or hereinafter developed.

The mower 10 may include an electrical storage device such as primary battery 32 (FIG. 4), which may be made up of one or more individual batteries or battery packs. The primary battery 32 is not shown in FIGS. 1-3 and may be covered by the body or frame 14 of the mower 10 such as by being located in an area underneath the operator seat 24. The primary battery 32 is electrically connected to both the drive motors 28 and the accessory motors 30 to deliver power to each. The mower 10 may also include a backup or auxiliary electrical storage device or battery 34 that may be electrically connected to the drive motors 28. As shown in FIG. 1, the auxiliary battery 34 may be located on a side of the mower 10, and the auxiliary battery 34 may be of a portable size such that an operator can detach or attach the auxiliary battery 34 as desired. In some embodiments, two or more auxiliary batteries 34 may be used. For example, one auxiliary battery 34 may be located on a left side of the mower 10 and another auxiliary battery 34 may be located on a right side of the mower 10. The primary battery 32 and auxiliary batteries 34 may be configured as any suitable electrical storage device, including lead-acid batteries, lithium-ion batteries or other types of batteries or electrical energy storage components.

The mower 10 may include an electric generator 36 for producing electricity to charge the primary battery 32 and auxiliary batteries 34 and/or to provide electricity directly to the drive motors 28 and accessory motors 30. The generator 36 may include an engine 38, such as a gas or diesel powered engine, that powers the generator 36 to produce electricity. As shown in FIGS. 1-3 the generator 36 may be located on a rearward portion of the mower 10. As shown in the illustrated embodiments, the engine 38 may be integrally included in the generator 36. In some embodiments, the engine 38 may be separate from the generator 36 and mechanically coupled thereto to “drive” or power the generator 36.

Turning to FIG. 4, the hybrid power system of the mower 10 is described. Before the mower 10 is put into operation, a user may fully charge the primary battery 32 and auxiliary batteries 34. For example, the mower 10 may be plugged into a charger or electric power source 40, such as a standard electric outlet. In some embodiments, the generator 36 may include a receptacle for receiving a standard charging plug or adapter or the generator 36 may include an integrated cord that can be plugged into a charger or electric outlet. As such, the same electrical connections from the generator 36 to the batteries 32, 34 may be used to charge the batteries 32, 34 during the operation of the generator 36 or during charging using the off-mower electric power source 40 when the mower 10 is not in operation (e.g., when stored in a garage or shed).

When a user starts the mower 10 with a charged primary battery 32, the primary battery 32 can power both the drive motors 28 and accessory motors 30. This may be defined as a first operating condition of the mower 10. In the first operating condition, the generator 36 (and engine 38) are in the off position and all power to operate the motors 28 and 30 are supplied by the primary battery 32. Once the primary battery 32 reaches a low threshold level or low threshold charge, the mower 10 may automatically turn on the engine 38 so that the generator 36 begins to produce and deliver electricity to the motors 28, 30. Any excess electricity produced by the generator 36 not consumed by the motors 28, 30 may be used to recharge the primary battery 32. This may be defined as a second operating condition of the mower 10. The generator 36 may continue to power the motors 28, 30 (i.e., the mower 10 is in the second operating condition) until the primary battery 32 reaches a high threshold level or high threshold charge. Once the primary battery 32 reaches high threshold charge, the generator 36 (and engine 38) may shut off and the primary battery 32 may resume powering the motors 28, 30 (i.e., the mower 10 transitions to the first operating condition). The low threshold charge level and high threshold charge levels may be selected to balance performance, ease of use, frequency of start/stops of the and generator 36, or for other criteria. In one non-limiting example, the low threshold charge level may be set between 5-30% of full capacity and the high threshold charge level may be set between 70-100% of full capacity. In some embodiments, the low threshold charge level may be set at 10% and the high threshold charge level may be set at 80%.

The mower 10 may continue to cycle between being powered by the primary battery 32 (first operating condition) and being powered and recharged by the generator 36 (second operating condition) until the engine 38 runs out of fuel or reaches a set low-fuel threshold. In the event the primary battery 32 also reaches a low charge state, the mower 10 may shut off entirely. At this point, the operator may switch the mower 10 to backup power that utilizes the auxiliary batteries 34. This may be defined as the third operating condition. The control unit 42 may be configured such that it does not switch the mower 10 to backup power (i.e., the third operating condition) without operator intervention to select backup power using the controls. The auxiliary batteries 34 may be used to power the drive motors 28 but not the accessory motor 30. The auxiliary batteries 34 can provide enough power to allow a user to drive the mower 10 back to get fuel and/or to an electric power source 40 to refuel the generator 36 and/or recharge the primary battery 32 for further operation.

The generator 36 and primary battery 32 may be sized to provide the mower 10 with sufficient range to mow large yards or other tracts of land. For example, the primary battery 32 may be a 24-72 volt battery, such as a 54 volt battery. Batteries rated at a greater or lesser voltage may also be used for the primary battery 32. The mower 10 may be capable of mowing five acres or more before needing to return for refueling and/or recharging from a separate electric source. The auxiliary batteries 34 may be sized to ensure that even if the primary battery 32 and generator 36 run out of charge and fuel at a farthest point from the starting point where the mower 10 began mowing, the auxiliary batteries 34 can provide the mower 10 with enough driving range to return to the starting point to recharge and/or refuel.

A CPU or control unit 42 may read the charge status of the primary battery 32 and automatically switch between battery power (first operating condition) or generator power (second operating condition) depending on the level of charge. The automatic nature of the control unit 42 optimally switching between battery power or generator power can make operating the mower 10 more user friendly and efficient than having to manually switch between power states. The control unit 42 may determine a charge of one of the batteries 32, 34 by taking a voltage reading. of the batteries 32, 34. The voltage may be sampled multiple times and averaged to provide a smoother or continuous voltage reading of the batteries 32, 34 for the control unit 42 to respond to than if the control unit 42 responded to each instantaneous voltage reading. For example, the voltages may be sampled at approximately ten times per second and averaged over approximately three to five seconds.

As shown in FIG. 1, the mower 10 may include a display or screen 44 that can visually show an operator various aspects of the mower 10 operation. For example, the screen 44 may show the charge level of the batteries 32, 34, power draw of the motors 28, 30, fuel level of the engine 38 and generator 36, which components are powering the motors 28, 30, estimated remaining time of operation until needing to return for fuel or charging, among other aspects. In some embodiments, the screen 44 may be a touchscreen that the user can interact with or there may be other buttons or controls for interacting with the screen 44 to display different aspects. In some embodiments, the controls may allow a user to adjust how the mower operates (e.g., change the battery low and high level threshold settings, manually change between battery power or generator power, etc.).

Returning to FIG. 4, the mower 10 may also be configured to operate with the motors 28, 30 powered by both the primary battery 32 and the generator 36. If the primary battery 32 is supplying electricity to the motors 28, 30 with the generator 36 off and the power demand of the motors 28, 30 exceeds the electric draw that the primary battery 32 can provide, the mower 10 may be configured to transition to a fourth operating condition where the generator 36 may automatically start and begin supplying extra electric power, along with the primary battery 32, to the motors 28, 30. For example, power demand of the motors 28, 30 could exceed the output of the primary battery 32 when the mower 10 is being driven up an incline or hill or when the mower 10 enters a patch of thick grass such that the cutting unit 18 and accessory motor 30 require more power. The control unit 42 can detect the increased power draw and automatically turn on the generator 36. Once turned on, the mower 10 may continue in the fourth operating condition and the generator 36 may continue to operate and recharge the primary battery 32 as well as supply electricity to the motors 28, 30 as needed until the primary battery 32 reaches a second high threshold charge level. This second high threshold charge level may be equal to or greater than the high threshold charge level used to control the transition from the second operating condition back to the first operating condition. For example, according to the embodiment described above where the high threshold level is 80% charge of the primary battery 32, the second high threshold charge level may be set at 90% charge of the primary battery 32. This can help reduce the number of start/stops experienced by the engine 38 and generator 36, which can help extend their working life. In some embodiments, the primary battery 32 may stop powering the motors 28, 30 when the power demand exceeds the electric draw that the primary battery 32 can provide, and the generator 36 may supply all the power to the motors 28, 30 and recharge the primary battery 32 similar to the second operating condition.

In some alternative embodiments, the engine 38 may be mechanically coupled to one or more of drive wheels 12 and cutting unit 18 in addition to the generator 36. In such embodiments, the engine 38 may provide direct power to the drive wheels 12 or cutting unit 18 while also powering the generator 36 to recharge the primary battery 32.

As best shown in FIG. 3, the generator 36 may be located at a rearward portion of the mower 10 behind the operator seat 24. The generator 36 may be removable from the mower 10 such that the generator 36 can be used separately from the mower 10 to power electrical equipment as desired. The generator 36 may also be used to power equipment while secured to the mower 10. The generator 36 may be physically secured and electrically connected to the mower 10 using quick disconnect type fittings such that a user can quickly and easily remove or re-attach the generator 36 to the mower 10. The generator 36 and engine 38 may be rated to power large appliances or equipment (e.g., a 2,000-8,000 watt generator 36, such as a 4,000 watt or 4,500 watt generator 36). The generator 36 may also be sized and rated at any suitable watt capacity, including those greater or lesser than 2,000-8,000 watts. The generator 36 may include a pull cord 46 to manually pull start the engine 38 and generator 36 when the generator 36 is not connected to the mower 10 or any other battery or electric source for starting the engine 38. When the generator 36 is connected to the mower 10, the controls of the mower 10 may be used to start the generator 36.

The generator 36 may include various receptacles for connecting to various power cables. For example, the generator 36 may include two outlet receptacles (e.g., 15 amp, 120 volt plug receptacles) and two USB receptacles (e.g., 5 volt USB-A and 5 volt USB-C) to provide flexibility in the types of equipment the generator 36 can power. The receptacles may be protected by a lid or cover 48 that helps shield the receptacles from dust, moisture, and other elements when the receptacles are not in use.

As best shown in FIGS. 1 and 3, the mower 10 may include a rollover bar 50 to protect a user during operation of the mower 10. The rollover bar 50 may include a rearwardly extending portion 52 and a hinged portion 54 such that the rearwardly extending portion 52 may be pivoted upwards about the hinged portion 54 to provide greater access to the rear end of the mower 10 (e.g., provide greater access to the generator 36). The hinged portion 54 may be locked into position or unlocked by using pins, for example. The mower 10 may include a cargo carrier 56, which may be located at the rear of the mower 10 above the generator 36. The cargo carrier 56 can be used to carry various supplies, tools, or other cargo as desired. Additionally, the mower 10 may include a hitch 58 for connecting and pulling a trailer or wheeled equipment behind the mower 10.

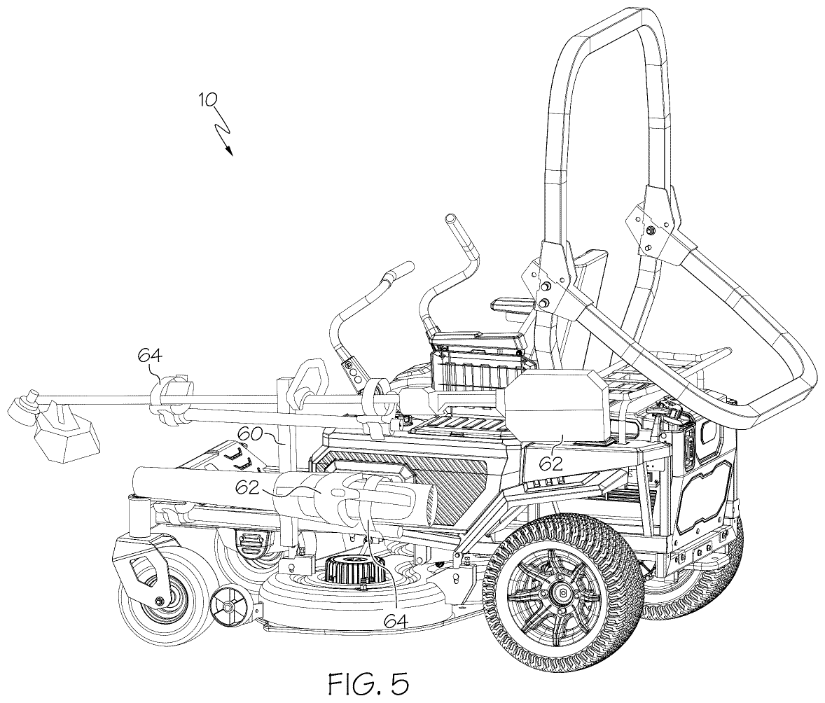

As shown in FIG. 5, the mower 10 may include a rack or support 60 for carrying various power equipment or lawncare equipment 62 including string trimmers (weed eaters), leaf blowers, hedge trimmers, chainsaws, and the like. The support 60 may include brackets or straps 64 for securing the lawncare equipment 62 to the support 60 while allowing a user to easily remove the lawncare equipment 62 when needed. The brackets or supports 64 may be configured as any suitable component that can secure the accessory equipment 62 to the support 60 while also allowing for selective removable and re-attachment of the equipment 62. The auxiliary batteries 34, which are removable from the mower 10, can be sized to fit standard lawncare equipment 62. For example, the auxiliary battery 34 may be a 62-volt battery commonly used for standard lawncare equipment 62 or other types of equipment. A user can stop the mower 10 and use the lawncare equipment 62 as needed while mowing and performing other landscaping services on a lawn or field. The auxiliary batteries 34 on the mower 10 may be removed to supply power to the lawncare equipment 62 or replace a dead battery on the lawncare equipment 62. The dead battery may be attached to the mower 10 (or auxiliary battery 34 reattached) such that the dead battery or auxiliary battery 34 may recharge when the mower 10 resumes operation and the generator 36 turns on during normal use.

The foregoing has been described primarily in relation to a riding mower unit. It will be apparent to one skilled in the art that the embodiments described herein could likewise be used for other vehicles or outdoor power equipment, including other types of mowers such as zero turn mowers, tractors, rear engine rides, walking mowers, and including UTVs, ATVs, motor bikes, go-karts, golf carts, and recreational vehicles among many others. In such embodiments (not shown), the vehicle or mobile unit 10 may similarly include a primary storage device or battery 32 that is connected to and configured to supply power to one or more electric motors 28 that operate one or more drive wheels 12 for moving the unit 10. Optionally, the unit 10 may include one or more optional motors 30 connected to and powered by the battery device 32 and configured for operating one or more accessory systems 18, and one or more optional auxiliary battery devices 34 that are connected to the electric motors 28 and 30. For example, the accessory system 18 may include wenches, lights, snow blower attachments, cultivators/tillers, among many other systems and powered tools. As also described above, the unit 10 may include a generator 36 powered by an integrated or separate internal combustion engine 38, where the generator 36 is connected to the primary battery device 32 and auxiliary battery devices 34. The control unit 42 may be configured to operate the unit 10 by controlling the operating condition of the unit 10 in the same manner as described above with respect to mower 10.

The embodiment(s) described above and illustrated in the figures are presented by way of example only and are not intended as a limitation upon the concepts and principles of the present disclosure. As such, it will be appreciated that variations and modifications to the elements and their configuration and/or arrangement exist within the spirit and scope of the following claims.

Persons of ordinary skill in the relevant arts will recognize that the subject matter hereof may comprise fewer features than illustrated in any of the individual embodiments described above. The embodiments described herein are not meant to be an exhaustive presentation of how the various features of the subject matter herein may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

The numerical ranges in this disclosure are approximate, and thus may include values outside of the range unless otherwise indicated. Numerical ranges include all values from and including the lower and the upper values, in increments of one unit, provided that there is a separation of at least two units between any lower value and any higher value. These are only examples of what is specifically intended, and all possible combinations of numerical values between the lowest value and the highest value enumerated, are to be considered to be expressly stated in this disclosure.

As used herein, “a,” “an,” or “the” can mean one or more than one. For example, “an” image can mean a single image or a plurality of images.

The term “and/or” as used in a phrase such as “A and/or B” herein can include both A and B; A or B; A (alone); and B (alone). Likewise, the term “and/or” as used in a phrase such as “A, B, and/or C” can include at least the following embodiments: A, B, and C; A, B, or C; A or C; A or B; B or C; A and C; A and B; B and C; A (alone); B (alone); and C (alone).

As used herein, the terms “about” and “approximately” when referring to a measurable value such as an amount, a temporal duration, and the like, can include variations of +/−20%, more preferably +/−10%, even more preferably +/−5% from the specified value, as such variations are appropriate to reproduce the disclosed methods and systems.

From the foregoing, it will be seen that this invention is one well adapted to attain all the ends and objects hereinabove set forth together with other advantages which are obvious and which are inherent to the structure. It will be understood that certain features and sub combinations are of utility and may be employed without reference to other features and sub combinations. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention.

What is claimed is:

1. A mower comprising:
a frame;
a drive wheel for propelling the mower, the drive wheel coupled to the frame;
a cutting unit configured to cut grass;
a first motor operatively connected to the drive wheel;
a second motor operatively connected to the cutting unit;
a primary energy storage device electrically connected to the first motor and the second motor to power the first motor and the second motor;
an auxiliary energy storage device electrically connected to the first motor to power the first motor;
a generator electrically connected to the first motor and the second motor to selectively power the first motor and the second motor, the generator further electrically connected to the primary energy storage device and the auxiliary energy storage device to selectively charge the primary energy storage device and the auxiliary energy storage device;
a control unit configured to operate the mower in a first operating condition in which the primary energy storage device electrically powers the first motor and the second motor and a second operating condition in which the generator electrically powers the first motor and the second motor and charges the primary energy storage device and auxiliary energy storage device; and
a control switch configured to operate the mower in a third operating condition in which the auxiliary energy storage device electrically powers the first motor when the control switch is selected.

2. The mower of claim 1, wherein the control unit is configured to measure a charge level of the primary energy storage device, wherein, when the mower is in the first operating condition and the charge level of the primary energy storage device is measured at or below a low threshold, the control unit switches the mower to the second operating condition, and wherein, when the mower is in the second operating condition and the charge level of the primary energy storage device is measured at or above a high threshold, the control unit switches the mower to the first operating condition.

3. The mower of claim 2, wherein the low threshold is approximately 10% of a total charge capacity of the primary energy storage device, and wherein the high threshold is approximately 80% of the total charge capacity of the primary energy storage device.

4. The mower of claim 1, wherein the control unit can measure a power draw of the first motor and the second motor, and wherein, when the mower is in the first operating condition and the power draw of the first motor and the second motor exceeds a high power threshold, the control unit switches the mower to a fourth operating condition in which the primary energy storage device powers the first motor and the second motor, and the generator powers the first motor and the second motor.

5. The mower of claim 1, wherein the control unit can measure a power draw of the first motor and the second motor, and wherein, when the mower is in the first operating condition and the power draw of the first motor and the second motor exceeds a high power threshold, the control unit switches the mower to the second operating condition.

6. The mower of claim 1, wherein the auxiliary energy storage device is detachable from the mower, and wherein the auxiliary energy storage device is configured to couple to and power a lawncare equipment device separate from the mower.

7. The mower of claim 6, wherein mower includes a rack for securing the lawncare equipment device to the mower.

8. The mower of claim 1, wherein the generator includes a receptacle configured to supply electric power to an appliance.

9. The mower of claim 1, wherein generator is electrically and mechanically detachable from the mower, and wherein the generator includes a pull start configured to turn the generator on when the generator is detached from the mower.

10. A mower comprising:
a frame;
a drive wheel for propelling the mower, the drive wheel coupled to the frame;
a cutting unit configured to cut grass;
a first motor operatively connected to the drive wheel;
a second motor operatively connected to the cutting unit;
a primary battery electrically connected to the first motor and the second motor to power the first motor and the second motor;
a generator electrically connected to the first motor and the second motor to selectively power the first motor and the second motor, the generator further electrically connected to the primary battery to selectively charge the primary battery; and
a control unit that can measure a charge level of the primary battery, the control unit configured to operate the mower in a first operating condition in which the primary battery electrically powers the first motor and the second motor and a second operating condition in which the generator electrically powers the first motor and the second motor and charges the primary battery;
wherein, when the mower is in the first operating condition and the charge level of the primary battery is measured at or below a low threshold, the control unit switches the mower to the second operating condition;
wherein, when the mower is in the second operating condition and the charge level of the primary battery is measured at or above a high threshold, the control unit switches the mower to the first operating condition.

11. The mower of claim 10, wherein the control unit can measure a power draw of the first motor and the second motor, and wherein, when the mower is in the first operating condition and the power draw of the first motor and the second motor exceeds a high power threshold, the control unit switches the mower to the second operating condition.

12. The mower of claim 10, wherein the low threshold is set approximately between 5% and 30% of a total charge capacity of the primary battery, and wherein the high threshold is set approximately between 70% and 100% of the total charge capacity of the primary battery.

13. The mower of claim 10, wherein the generator includes a receptacle configured to supply electric power to an appliance.

14. The mower of claim 13, wherein generator is electrically and mechanically detachable from the mower, and wherein the generator includes a pull start configured to turn the generator on when the generator is detached from the mower.

15. A method of operating a mower, the method comprising:
providing a mower comprising:
a drive wheel for propelling the mower;
a cutting unit configured to cut grass;
a first motor operatively connected to the drive wheel;
a second motor operatively connected to the cutting unit;
a primary battery electrically connected to the first motor and the second motor to power the first motor and the second motor;
an auxiliary battery electrically connected to the first motor to power the first motor;
a generator electrically connected to the first motor and the second motor to selectively power the first motor and the second motor, the generator further electrically connected to the primary battery and the auxiliary battery to selectively charge the primary battery and the auxiliary battery; and
a control unit that can measure a charge level of the primary battery;
operating the mower in a first operating condition in which the primary battery electrically powers the first motor and the second motor; and
switching the mower to operate in a second operating condition in which the generator electrically powers the first motor and the second motor and charges the primary battery and auxiliary battery.

16. The method of claim 15, wherein the control unit switches the mower to operate in the second operating condition when the control unit measures the charge level of the primary battery is at or below a low threshold.

17. The method of claim 15, further comprising an operator selecting to put the mower in a third operating condition in which the auxiliary battery electrically powers the first motor.

18. The method of claim 15, further comprising stopping the mower and removing the generator from the mower.

19. The method of claim 15, further comprising stopping the mower and using the generator to power an appliance separate from the mower.

20. The method of claim 15, further comprising stopping the mower and removing the auxiliary battery for use in powering a lawncare equipment device separate from the mower.
